(19) United States
(12) Patent Application Publication
(10) Pub. No.: US 2017/0163702 A1
(43) Pub. Date: Jun. 8, 2017

(54) ANDROID PLATFORM-BASED MULTIMEDIA PROCESSING METHOD AND ELECTRONIC DEVICE

(71) Applicants: Le Holdings (Beijing) Co., Ltd., Beijing (CN); Le Shi Internet Information & Technology Corp., Beijing, Beijing (CN)

(72) Inventor: Xuehui SHI, Beijing (CN)

(21) Appl. No.: 15/348,063

(22) Filed: Nov. 10, 2016

Related U.S. Application Data
(63) Continuation of application No. PCT/CN2016/096785, filed on Aug. 25, 2016.

(30) Foreign Application Priority Data
Dec. 2, 2015 (CN) 201510876155.6

(51) Int. Cl. H04L 29/06; H04N 21/431; H04N 21/44; H04N 21/472; H04N 21/414

(52) U.S. Cl. CPC H04L 65/60; H04N 21/47217; H04N 21/41407; H04N 21/44004; H04N 21/4312

(57) ABSTRACT

An Android platform-based multimedia processing method and electronic device are provided, where a first multimedia resource is played by a first playback window on an Android platform; and the Android platform-based multimedia processing method includes: acquiring processing progress of the first multimedia resource; when the processing progress meets a progress switch condition, sending a playback request to a server, where the playback request is used to request to play a second multimedia resource; and preloading the second multimedia resource by a second playback window.

### CROSS-REFERENCE TO RELATED APPLICATIONS

The application is a continuation application of PCT Application No. PCT/CN2016/096785, filed on Aug. 25, 2016, which is based on and claims priority to Chinese Patent Application No. 201510876155.6, entitled “ANDROID PLATFORM-BASED MULTIMEDIA PROCESSING METHOD AND APPARATUS AND MOBILE TERMINAL DEVICE”, and filed on Dec. 2, 2015, both of which are incorporated herein by reference in its entireties.

### TECHNICAL FIELD

This disclosure relates to the field of video playback, and in particular, to an Android platform-based multimedia processing method and electronic device.

### BACKGROUND

Currently, when an Android platform-based video player plays videos continuously, when a multimedia resource in a playback window ends, a next multimedia resource can be played only after a next playback window is called and buffering is performed for a period of time. In a process of watching a video, a user generally waits for different duration due to a limitation of a network speed or performance of a playback device.

### SUMMARY

This disclosure provides an Android platform-based multimedia processing method and electronic device, to implement seamless switch of multimedia resources during playing of a video.

According to an aspect, an embodiment of this disclosure provides an Android platform-based multimedia processing method, where a first multimedia resource is played by a first playback window on an Android platform, and the method includes: acquiring processing progress of the first multimedia resource; when the processing progress meets a progress switch condition, sending a playback request to a server, where the playback request is used to request to play a second multimedia resource; and preloading the second multimedia resource by a second playback window.

According to another aspect, an embodiment of this disclosure provides a non-transitory computer-readable storage medium storing executable instructions that, when executed by an electronic apparatus, cause the electronic apparatus to perform any Android platform-based multimedia processing method described in the above disclosure

According to another aspect, an embodiment of this disclosure provides an electronic apparatus. The electronic apparatus includes: at least one processor; and a memory communicably connected with the at least one processor for storing instructions executable by the at least one processor, wherein execution of the instructions by the at least one processor causes the at least one processor to perform any Android platform-based multimedia processing method described in the above disclosure.

According to the Android platform-based multimedia processing method and electronic device provided by some embodiments, on an Android platform, when a user watches a first multimedia resource, a second multimedia resource is preloaded, thereby implementing seamless switch between the first multimedia resource and the second multimedia resource, and avoiding waiting for different duration caused by a limitation of a network speed or performance of a playback device during watching.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of an Android platform-based multimedia processing method according to an embodiment of this disclosure;

FIG. 2 is a schematic structural diagram of a multimedia preview apparatus according to an embodiment of this disclosure; and

FIG. 3 is a schematic structural diagram of hardware of an electronic device for performing an Android platform-based multimedia processing method according to an embodiment of this disclosure.

### DETAILED DESCRIPTION

The following describes exemplary embodiments of this disclosure in detail with reference to the accompanying drawings.

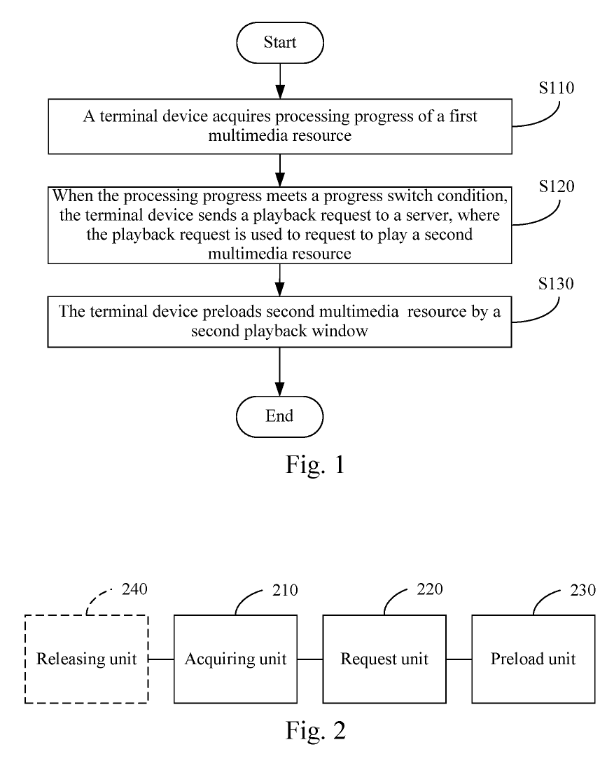

FIG. 1 is a flowchart of an Android platform-based multimedia processing method according to an embodiment of this disclosure.

Referring to FIG. 1, a first multimedia resource is played by a first playback window on an Android platform, and the Android platform-based multimedia processing method includes:

The first multimedia resource may include, but is not limited to an audio and/or a video. Optionally, the first multimedia resource is played by the first playback window on the Android platform in this embodiment in full screen mode, for example, includes, but is not limited to, playing the first episode of Nirvana in Fire by a first playback window of a video APP.

In step S110, a terminal device acquires processing progress of the first multimedia resource.

Specifically, the foregoing processing progress includes buffering progress and playing progress of the first multimedia resource by the terminal device.

In this embodiment, the user plays the first multimedia resource online by the first playback window on the Android platform. The Android platform refers to a terminal device installed with an Android system. Processing performed by the Android platform on the first multimedia resource mainly includes creating a thread of the first playback window, downloading the first multimedia resource by the thread of the first playback window, putting a part of the downloaded first multimedia resource into a buffer of a system (that is, buffering the first multimedia resource), calling the first playback window, and presenting the buffered first multimedia resource (that is, playing the first multimedia resource) to the user by a displayer.

In the process in which the first multimedia resource is played by the first playback window, buffering progress of the first multimedia resource is always faster or equal to playing progress of the first multimedia resource. For example, in this embodiment, the first multimedia resource is the first episode of Nirvana in Fire. When the 10ₜₕ minute and 25ₜₕ second of the first episode of Nirvana in Fire is played by the first playback window, content of the first episode of Nirvana in Fire before the 20ₜₕ minute and 22_{nd} second of the first episode is buffered in a background thread. When the 30ₜₕ minute and 5ₜₕ second of the first episode of Nirvana in Fire is played by the first playback window, content of the first episode of Nirvana in Fire before the 44ₜₕ minute and 30ₜₕ second is buffered in a background thread. The buffering progress of the first multimedia resource and the playing progress of the first multimedia resource may be represented by numerical values of duration, or may be presented by a ratio of buffering or playing duration to total duration of the first multimedia resource. A description is provided by an example in which duration of the first episode of Nirvana in Fire is 45 minutes. When 13% of the first episode of Nirvana in Fire is played by the first playback window, 22% of the first episode of Nirvana in Fire is buffered in the background thread. When 37% of the first episode of Nirvana in Fire is played by the first playback window, 99% of the first episode of Nirvana in Fire is buffered in the background thread.

In step S120, when the processing progress meets a progress switch condition, the terminal device sends a playback request to a server, where the playback request is used to request to play a second multimedia resource.

Specifically, the foregoing progress switch condition is that buffering of the first multimedia resource ends.

In this embodiment, after buffering of the first multimedia resource ends (generally, at this time, the first multimedia resource is not completely played), specifically, that is, a buffered part of the first multimedia resource in the first playback window is already of duration of the first multimedia resource, for example, 45 minutes, or the first playback window has buffered 100% of the first multimedia resource, the terminal device directly sends a playback request to a server. The playback request is used to request to play a second multimedia resource.

In step S130, the terminal device preloads the second multimedia resource by a second playback window.

Specifically, after the terminal device sends the playback request to the server, the server provides information of the second multimedia resource for the terminal device. The terminal device preloads the second multimedia resource by the second playback window. When the first episode is not completely watched but has already been buffered, the terminal device automatically buffers the second episode, and locally stores buffered information of the second episode, so that the second episode waits to be displayed by the second playback window.

A method for preloading the second multimedia resource by a second playback window in this embodiment may include:

The system creates a second playback window thread. In this time, a first playback window thread continues to present a first multimedia resource to the user by a displayer. Playing progress of the first playback window thread continues.

The second multimedia resource is downloaded by the second playback window thread, and a part of the downloaded second multimedia resource is put in a buffer of the system (that is, buffering the second multimedia resource).

For example, the first multimedia resource is the first episode of Nirvana in Fire, the second multimedia resource is the second episode of Nirvana in Fire, and duration of the first episode of Nirvana in Fire is 45 minutes. When the user watches the 23_{rd} minute and 30ₜₕ second of the first episode of Nirvana in Fire by the first playback window, and the first playback window has buffered content of the first episode of 45 minutes of Nirvana in Fire (buffering is completed), the user continues to watch the first episode of Nirvana in Fire by the first playback window, and the system sends a playback request of the second episode of Nirvana in Fire to the server. The server provides information of the second episode of Nirvana in Fire for the terminal device. The system creates a second playback window thread, starts to download the second episode of Nirvana in Fire, and locally stores a part of the second episode of Nirvana in Fire.

Further, the method further includes: when the processing progress meets a progress ending condition, releasing the first playback window and displaying the second playback window. Specifically, the progress ending condition is that playing of the first multimedia resource ends.

When playing of the first multimedia resource ends, the terminal device releases the first playback window and displays the second playback window. In this embodiment, when a player is switched to the second playback window, the second multimedia resource has buffered resource information. Therefore, the user can directly watch the resource without waiting.

Optionally, during buffering of the second multimedia resource, the second playback window has already existed, but the terminal device does not display the second playback window to the user. When two windows are switched, the terminal device directly displays the second playback window and turns off the first playback window, to reduce window switch time.

For example, the first multimedia resource is the first episode of Nirvana in Fire, the second multimedia resource is the second episode of Nirvana in Fire, and duration of the first episode of Nirvana in Fire is 45 minutes. When the user watches the 45ₜₕ minute of the first episode of Nirvana in Fire by the first playback window, the system releases the first playback window thread, calls the second playback window thread, and presents a part of the locally stored second episode of Nirvana in Fire to the user by a displayer.

Further, the first multimedia resource and the second multimedia resource may be audios and/or videos.

According to the Android platform-based multimedia processing method in this embodiment of this disclosure, on an Android platform, when a user watches a first multimedia resource, a second multimedia resource is preloaded, thereby implementing seamless switch between the first multimedia resource and the second multimedia resource, and avoiding waiting for different duration caused by a limitation of a network speed or performance of a playback device during watching.

FIG. 2 is a schematic structural diagram of an Android platform-based multimedia processing apparatus according to an embodiment of this disclosure.

Referring to FIG. 2, a first multimedia resource is played by a first playback window on an Android platform, and the apparatus includes an acquiring unit 210, a request unit 220, and a preload unit 230.

The acquiring unit 210 is configured to acquire processing progress of the first multimedia resource.

The request unit 220 is configured to: when the processing progress acquired by the acquiring unit 210 meets a progress switch condition, send a playback request to a server, where the playback request is used to request to play a second multimedia resource.

The preload unit 230 is configured to preload, by a second playback window, the second multimedia resource requested by the request unit 220.

Specifically, the progress switch condition is that buffering of the first multimedia resource ends.

The preload unit includes:

an calling subunit (which is not shown in the figure), configured to call the second playback window;

a buffering subunit (which is not shown in the figure), configured to buffer the second multimedia resource by the second playback window called by the calling subunit; and

a storage subunit (which is not shown in the figure), configured to locally store the second multimedia resource buffered by the buffering subunit. Further, the apparatus further includes a releasing unit 240.

The releasing unit 240 is configured to: when the processing progress acquired by the acquiring unit 210 meets a progress ending condition, release the first playback window and display the second playback window.

Specifically, the progress ending condition is that playing of the first multimedia resource ends.

According to the Android platform-based multimedia processing apparatus in this embodiment of this disclosure, on an Android platform, when a user watches a first multimedia resource, a second multimedia resource is preloaded, thereby implementing seamless switch between the first multimedia resource and the second multimedia resource, and avoiding waiting for different duration caused by a limitation of a network speed or performance of a playback device during watching.

According to an embodiment of the present disclosure, there is provided with a non-transitory computer-readable storage medium storing executable instructions that, when executed by an electronic device, cause the electronic device to perform any one of above disclosed methods.

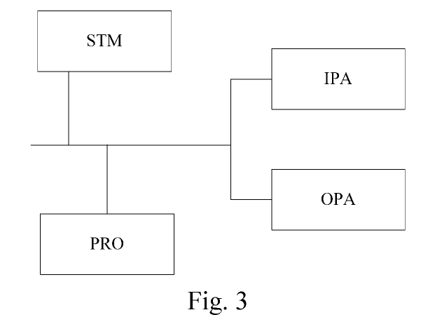

FIG. 3 illustrates a schematic structural hardware diagram of hardware of an electronic device for performing an Android platform-based multimedia processing method according to an embodiment of this disclosure. As shown in FIG. 3, the device includes:

at least one processor PRO and a memory STM, FIG. 3 shows one processor PRO as an example.

The device for performing an Android platform-based multimedia processing method can further include: an input apparatus IPA and an output apparatus OPA.

The processor PRO, the memory STM, the input apparatus IPA, and the output apparatus OPA can be connected by means of a bus or in other manners. FIG. 3 shows a bus as an example for connection.

As a non-transitory computer-readable storage medium, the memory STM can be used to store non-transitory software programs, non-transitory computer-readable executable programs and modules, for example, a program instructions/module for performing the Android platform-based multimedia processing method in the embodiments of this disclosure (for example, the releasing unit 240, the acquiring unit 210, the request unit 220, and the preload unit 230 shown in FIG. 2). The processor PRO may operate the various functions and data processing of a server, that is, implements the Android platform-based multimedia processing method of the foregoing method embodiments, by executing non-transitory software programs, instructions, and modules that are stored in the memory STM.

The memory STM may include a program storage area and a data storage area. Among them, the program storage area may store operation system, disclosure programs of at least one function; the data storage area may store generated data during operation of the electronic apparatus for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRO. The remote storage medium may be connected to the electronic apparatus for performing any of the above methods by a network. The examples of such as network include but not limited to Internet, enterprise intranet, local area network, mobile telecommunication network and a combination thereof.

The input apparatus IPA may receive input number or byte information, and may generate input key information relating to user setting and functional control of the Android platform-based multimedia processing apparatus. The output apparatus OPA may include a display device, for example, a display screen.

The one or more modules stored in the storage medium STM; that, when executed by the one or more processors PRS, may perform any of the above described methods.

The above products can perform any of the above described methods, and have corresponding functional modules and effects. Details that are not disclosed in this embodiment can be understood by reference to the above method embodiments of the present disclosure.

An electronic apparatus of the present disclosure may exist in a varied form and includes but not limited to:
(1) Mobile communication device: such devices are characterized by having a mobile communication function, and primarily providing voice and data communications; terminals of this type include: a smart phone (for example, an iPhone), a multimedia mobile phone, a functional phone, a low-end mobile phone, and the like;
(2) Ultra mobile personal computer device: such devices are essentially personal computers, which have computing and processing functions, and generally have the function of mobile Internet access; terminals of this type include: PDA, MID and UMPC devices, and the like, for example, an iPad;
(3) Portable entertainment device: such devices can display and play multimedia content; devices of this type include: an audio and video player (for example, an iPod), a handheld game console, an e-book, an intelligent toy and a portable vehicle-mounted navigation device;
(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and
(5) Other electronic apparatuses having a data interaction function.

The above described apparatus embodiments are for illustration purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiment.

Finally, it should be noted that the previous embodiments are provided to enable any person skilled in the art to practice the various embodiments of the present disclosure described herein but not to limit these aspects. Though the present disclosure is described by reference to the previous embodiments, various modifications and equivalent features will be readily apparent to those skilled in the art without departing from the spirit and scope of the present disclosure, and the generic principles defined herein may be applied to other aspects or with equivalent features. Thus, the claims are not intended to be limited to the aspects and features shown herein, but are to be accorded the full scope consistent with the language of the claims.

What is claimed is:

1. An Android platform-based multimedia processing method, wherein the method is performed by an electronic device, and a first multimedia resource is played by a first playback window on an Android platform; and the method comprises:
acquiring processing progress of the first multimedia resource;
when the processing progress meets a progress switch condition, sending a playback request to a server, wherein the playback request is used to request to play a second multimedia resource; and
preloading the second multimedia resource by a second playback window.

2. The method according to claim 1, wherein, further comprising:
when the processing progress meets a progress ending condition, releasing the first playback window and displaying the second playback window.

3. The method according to claim 1, wherein the preloading the second multimedia resource by a second playback window comprises:
calling the second playback window;
buffering the second multimedia resource by the second playback window; and
locally storing the buffered second multimedia resource.

4. The method according to claim 2, wherein the preloading the second multimedia resource by a second playback window comprises:
calling the second playback window;
buffering the second multimedia resource by the second playback window; and
locally storing the buffered second multimedia resource.

5. The method according to claims 1, wherein the progress switch condition is that buffering of the first multimedia resource ends.

6. The method according to claim 2, wherein the progress ending condition is that playing of the first multimedia resource ends.

7. A non-transitory computer-readable storage medium, which stores computer executable instructions that, when executed by an electronic device, cause the electronic device to:
acquire processing progress of a first multimedia resource, wherein the first multimedia resource is played by a first playback window on an Android platform;
when the processing progress meets a progress switch condition, send a playback request to a server, wherein the playback request is used to request to play a second multimedia resource; and
preload a second multimedia resource by a second playback window.

8. The non-transitory computer-readable storage medium according to claim 7, wherein the electronic device is further caused to:
when the processing progress meets a progress ending condition, release the first playback window; and
display the second playback window.

9. The non-transitory computer-readable storage medium according to claim 7, wherein the instructions to preload a second multimedia resource by a second playback window cause the electronic device to:
call the second playback window;
buffer the second multimedia resource by the second playback window; and
locally store the second multimedia resource buffered.

10. The non-transitory computer-readable storage medium according to claim 8, wherein the instructions to preload a second multimedia resource by a second playback window cause the electronic device to:
call the second playback window;
buffer the second multimedia resource by the second playback window; and
locally store the second multimedia resource buffered.

11. The non-transitory computer-readable storage medium according to claim 7, wherein the progress ending condition is that playing of the first multimedia resource ends.

12. The non-transitory computer-readable storage medium according to claim 8, wherein the progress switching condition is that playing of the first multimedia resource ends.

13. An electronic device, comprising:
at least one processor; and
a memory in communication connection with the at least one processor, wherein
the memory stores instructions that can be executed by the at least one processor, wherein execution of the instructions by the at least one processor causes the at least one processor to:
acquire processing progress of the first multimedia resource, wherein the first multimedia resource is played by a first playback window on an Android platform;
when the processing progress meets a progress switch condition, send a playback request to a server, wherein the playback request is used to request to play a second multimedia resource; and
preload a second multimedia resource by a second playback window.

14. The electronic device according to claim 13, wherein the at least one processor is further caused to:
when the processing progress meets a progress ending condition, release the first playback window; and
display the second playback window.

15. The electronic device according to claim 13, wherein the execution of the instructions to preload a second multimedia resource by a second playback window causes the at least one processor to:
call the second playback window;
buffer the second multimedia resource by the second playback window; and
locally store the second multimedia resource buffered.

16. The electronic device according to claim 14, wherein the execution of the instructions to preload a second multimedia resource by a second playback window causes the at least one processor to:
call the second playback window;
buffer the second multimedia resource by the second playback window; and
locally store the second multimedia resource buffered.

17. The electronic device according to claim 13, wherein the progress switching condition is that playing of the first multimedia resource ends.

18. The electronic device according to claim 14, wherein the progress switching condition is that playing of the first multimedia resource ends.
